(19) United States
(12) Patent Application Publication
(10) Pub. No.: US 2026/0203892 A1
(43) Pub. Date: Jul. 16, 2026

(54) MACHINE LEARNING-BASED IMAGE PROCESSING

(71) Applicant: TENCENT TECHNOLOGY (SHENZHEN) COMPANY LIMITED, Shenzhen (CN)

(72) Inventor: Jiangning ZHANG, Shenzhen (CN)

(73) Assignee: TENCENT TECHNOLOGY (SHENZHEN) COMPANY LIMITED, Shenzhen (CN)

(21) Appl. No.: 19/563,935

(22) Filed: Mar. 11, 2026

Related U.S. Application Data
(63) Continuation of application No. PCT/CN2024/123313, filed on Oct. 8, 2024.

(30) Foreign Application Priority Data
Nov. 29, 2023 (CN) 202311631619.8

(51) Int. Cl. G06T 7/00

(52) U.S. Cl. CPC G06T 7/001; G06T 2207/20081; G06T 2207/20084; G06T 2207/30108

(57) ABSTRACT

A machine learning-based image processing method is provided. In the method, a noise-added image corresponding to a first image is obtained by adding first noise data to the first image. The first image includes an image object. A semantic analysis is performed on the first image to obtain semantic analysis data representing the image object in the first image. Based on the semantic analysis data, an image denoising process is performed on the noise-added image, to obtain a second image; Based on a feature similarity between the first image and the second image, a defect recognition result corresponding to the first image is obtained. The defect recognition result indicates a defect condition of the image object in the first image. Apparatus and non-transitory computer-readable storage medium counterpart embodiments are also contemplated.

### RELATED APPLICATIONS

The present application is a continuation of International Application No. PCT/CN2024/123313, filed on Oct. 8, 2024, which claims priority to Chinese Patent Application No. 202311631619.8, filed on Nov. 29, 2023. The entire disclosures of the prior applications are hereby incorporated by reference.

### FIELD OF THE TECHNOLOGY

This disclosure relates to the field of machine learning, including image processing.

### BACKGROUND OF THE DISCLOSURE

Defect detection is commonly used in an industrial production process. Through detection of an image of a product, a manufacturing defect existing in the product can be determined.

In a related art, a defect detection manner is performed by pre-training a denoising model using a normal sample image, performing noise adding processing on a to-be-recognized product image, inputting the product image to the denoising model for denoising processing to obtain a denoised reconstructed image, and comparing a difference between the reconstructed image and the product image, to recognize an image object having a defect in the product image.

However, in the related art, in a process of denoising, by using the denoising model, a product image on which the noise adding processing is performed, a denoising error may occur. Consequently, image objects in the reconstructed image and the product image are inconsistent. As a result, an image object having the defect cannot be determined by comparing the reconstructed image and the product image, reducing recognition accuracy of image objects.

### SUMMARY

Embodiments of this disclosure provide an image processing method and apparatus, a device, a medium, and a program product, to improve recognition accuracy of an image object. The following provides technical solutions.

In an aspect, an image processing method is provided. In the method, a noise-added image corresponding to a first image is obtained by adding first noise data to the first image. The first image includes an image object. A semantic analysis is performed on the first image to obtain semantic analysis data representing the image object in the first image. Based on the semantic analysis data, an image denoising process is performed on the noise-added image, to obtain a second image; Based on a feature similarity between the first image and the second image, a defect recognition result corresponding to the first image is obtained. The defect recognition result indicates a defect condition of the image object in the first image.

In an aspect, an image processing apparatus is provided. The apparatus includes processing circuitry configured to obtain a noise-added image corresponding to a first image by adding first noise data to the first image. The first image includes an image object. The processing circuitry is configured to perform a semantic analysis on the first image to obtain semantic analysis data representing the image object in the first image. The processing circuitry is configured to perform, based on the semantic analysis data, an image denoising process on the noise-added image, to obtain a second image. The processing circuitry is configured to determine, based on a feature similarity between the first image and the second image, a defect recognition result corresponding to the first image, the defect recognition result indicating a defect condition of the image object in the first image.

In an aspect, a non-transitory computer-readable storage medium is provided. The storage medium stores instructions which when executed by at least one processor cause the at least one processor to perform an image processing method. In the method, a noise-added image corresponding to a first image is obtained by adding first noise data to the first image. The first image includes an image object. A semantic analysis is performed on the first image to obtain semantic analysis data representing the image object in the first image. Based on the semantic analysis data, an image denoising process is performed on the noise-added image, to obtain a second image; Based on a feature similarity between the first image and the second image, a defect recognition result corresponding to the first image is obtained. The defect recognition result indicates a defect condition of the image object in the first image.

In an aspect, an image processing method is provided, including: obtaining a noise-added image corresponding to a first image, the noise-added image being a result obtained by adding first noise data to the first image, and the first image including an image object; performing a semantic analysis on the first image to obtain semantic analysis data, the semantic analysis data being configured to represent information of the image object in the first image; performing, based on the semantic analysis data, image denoising processing on the noise-added image, to obtain a second image; and determining, based on a feature similarity between the first image and the second image, a defect recognition result corresponding to the first image, the defect recognition result including a defect condition of the image object.

In an aspect, an image processing apparatus is provided, including: an obtaining module, configured to obtain a noise-added image corresponding to a first image, the noise-added image being a result obtained by adding first noise data to the first image, and the first image including an image object; an analyzing module, configured to perform a semantic analysis on the first image to obtain semantic analysis data, the semantic analysis data being configured to represent information of the image object in the first image; a denoising module, configured to perform, based on the semantic analysis data, image denoising processing on the noise-added image, to obtain a second image; and a determining module, configured to determine, based on a feature similarity between the first image and the second image, a defect recognition result corresponding to the first image, the defect recognition result including a defect condition of the image object.

In an aspect, a computer device is provided. The computer device includes a processor (e.g., processing circuitry) and a memory, the memory having a computer program stored therein, the computer program being loaded and executed by the processor to implement the methods provided in the embodiments of this disclosure.

In an aspect, this disclosure provides a storage medium (e.g., a non-transitory computer-readable storage medium), the storage medium being configured to have a computer program stored therein, and the computer program being configured to execute the methods provided in the embodiments of this disclosure.

In an aspect, this disclosure provides a computer program product including a computer program, the computer program product, when run on a computer, causing the computer perform the methods provided in the embodiments of this disclosure.

Positive effects of the technical solutions provided in embodiments of this disclosure at least include: performing, after first noise data is added to a first image to obtain a noise-added image, a semantic analysis on the first image, to obtain semantic analysis data corresponding to information configured to represent an image object in the first image, so that image denoising processing is performed, based on the semantic analysis data, on the noise-added image, to obtain a second image. A defect condition corresponding to the first image is determined by comparing a feature similarity between the first image and the second image. In other words, in a manner of obtaining the semantic analysis data by performing the semantic analysis on the first image, image denoising is guided by using the semantic analysis data. Since a semantic analysis object may reflect information of the image object in the first image, during the image denoising, an image object in the noise-added image is indicated, to avoid removing partial composition of the image object as noise, to retain a complete image object in the second image to a greater extent. In this way, when similarity matching is subsequently performed, only a defect part of the image object in the first image is a cause of an insufficient similarity, but a display problem of the image object in the second image caused by denoising is not a cause of the insufficient similarity, thereby improving accuracy and recognition efficiency of image object defect recognition.

### BRIEF DESCRIPTION OF THE DRAWINGS

FIG. 1 is a schematic diagram of an implementation environment according to an embodiment of this disclosure.

FIG. 2 is a flowchart of an image processing method according to an embodiment of this disclosure.

FIG. 3 is a flowchart of an image processing method according to another embodiment of this disclosure.

FIG. 4 is a schematic diagram of a feature fusion process according to another embodiment of this disclosure.

FIG. 5 is a flowchart of an image processing method according to still another embodiment of this disclosure.

FIG. 6 is a flowchart of an image processing method training process according to still another embodiment of this disclosure.

FIG. 7 is a schematic diagram of an image processing method according to still another embodiment of this disclosure.

FIG. 8 is a schematic diagram of an effect of an image processing method according to still another embodiment of this disclosure.

FIG. 9 is a structural block diagram of an image processing apparatus according to an embodiment of this disclosure.

FIG. 10 is a structural block diagram of an image processing apparatus according to another embodiment of this disclosure.

FIG. 11 is a structural block diagram of a computer device according to an embodiment of this disclosure.

### DESCRIPTION OF EMBODIMENTS

To make objectives, technical solutions, and advantages of this disclosure clearer, the following describes implementations of this disclosure in further detail with reference to the accompanying drawings. The described embodiments are not to be considered as a limitation on the embodiments of this disclosure. Other embodiments are within the scope of this disclosure.

In this disclosure, terms such as “first” and “second” are used to distinguish the same items or similar items having the basically same function. Terms “first” and “second” have no logical or time sequence dependency relationship, and do not limit a quantity or a performing sequence.

In the following description, the use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

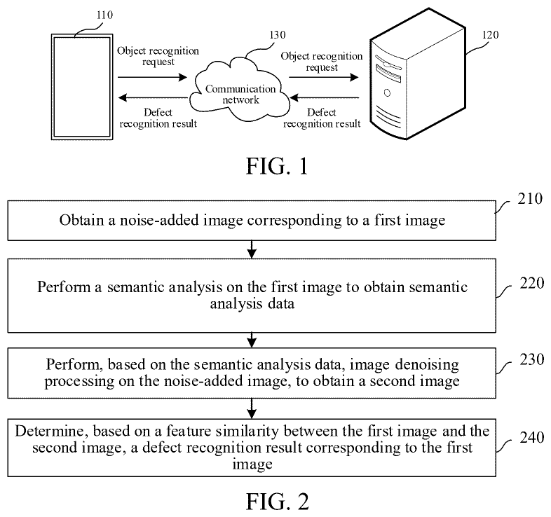

FIG. 1 is a schematic diagram of an implementation environment according to an embodiment of this disclosure. As shown in FIG. 1, the implementation environment includes a terminal 110, a server 120, and a communication network 130. The terminal 110 is connected to the server 120 through the communication network 130. In some embodiments, the communication network 130 may be a wired network, or may be a wireless network. This is not limited herein.

In an embodiment of this disclosure, the terminal 110 is configured to transmit data to the server 120. In some embodiments, the terminal 110 has a target application program having an image recognition function installed therein. This is not limited in this embodiment. For example, the target application program may be a related application program, may be a cloud application program, may be implemented as a mini program or an application module in a host application program, or may be a web platform. This is not limited in this embodiment.

After receiving a first image, the terminal 110 generates, based on the first image, an object recognition request, and transmits the object recognition request to the server 120. The object recognition request is configured to request to recognize an image object in the first image.

After receiving the object recognition request, the server 120 adds first noise data to the first image to obtain a noise-added image corresponding to the first image, and performs a semantic analysis on the first image to obtain semantic analysis data. The server 120 performs image denoising processing on the noise-added image based on the semantic analysis data, to obtain a second image, to determine, based on a feature similarity between the first image and the second image, a defect recognition result corresponding to the first image. The server 120 feeds the defect recognition result back to the terminal 110 for display.

Descriptions are provided in the foregoing by using an example in which the terminal 110 and the server 120 are used as a computer device. The computer device is an execution body for performing embodiments of this disclosure. In some embodiments, when the computer device is the terminal 110, the terminal 110 may be a smartphone, a tablet computer, a notebook computer, a desktop computer, an intelligent appliance, an intelligent in-vehicle terminal, an intelligent sound box, an intelligent voice interaction device, an aircraft, or the like, but is not limited thereto.

When the computer device is the server 120, the server 120 may be an independent physical server, a server cluster or a distributed system including a plurality of physical servers, or a cloud server providing a basic cloud computing service such as a cloud service, a cloud database, cloud computing, a cloud function, cloud storage, a network service, cloud communication, a middleware service, a domain name service, a security service, a content delivery network (CDN), big data, or an artificial intelligence platform.

A cloud technology refers to a hosting technology implementing computing, storage, processing, and sharing of data by unifying a series of resources such as hardware, software, and a network in a wide area network or a local area network. The cloud technology is a collective name of a network technology, an information technology, an integration technology, a management platform technology, an application technology, and the like based on application of a cloud computing business model. The cloud technology can constitute a resource pool, which can be used on demand flexibly and conveniently. A cloud computing technology becomes significant support. A background service of a technical network system, such as a video website, an image website, or more portal websites, needs a large number of computing resources and storage resources. With rapid development and application of the Internet industry, each object may have an own recognition mark in the future, and needs to be transmitted to a background system for logical processing. Data of different levels is processed separately, and data of various industries needs strong system support, which can be implemented only by the cloud computing. In some embodiments, the server 120 may alternatively be implemented as a node in a blockchain system.

With reference to the foregoing descriptions and the foregoing implementation environment, FIG. 2 is a flowchart of an image processing method according to an embodiment of this disclosure. The method may be performed by a computer device. The computer device, for example, may be the foregoing terminal, the server, or both the terminal and the server. This embodiment of this disclosure is described by using an example in which the method is performed by the server. The method includes the following operations:

Operation 210: Obtain a noise-added image corresponding to a first image.

The noise-added image is a result obtained by adding first noise data to the first image, the first image including an image object.

For example, the first image is an image including at least one image object.

In some embodiments, the first image is an R (red) G (green) B (blue) image.

Alternatively, the first image is a grayscale image.

In some embodiments, the image object in the first image is configured for defect recognition. The defect recognition refers to recognizing whether a defect part exists in the image object. For example, when the image object in the first image is a screw, whether the defect part exists on a screw head can be recognized according to this embodiment of this disclosure.

In some embodiments, the image object in the first image is displayed in a two-dimensional form; or the image object in the first image is displayed in a three-dimensional form.

In some embodiments, the noise data refers to data interfering image content in an image. For example, a noise may cause the image to become blurry, distorted, or contain random brightness or color variation.

In some embodiments, the noise data includes a saltpepper noise (black and white pixels randomly appearing in the image), a Gaussian noise (a pixel value of the image is affected by normally distributed random noise), an analog signal noise (a noise introduced due to interference such as a noise of an electronic element in a transmission and collection process of the image), a compression noise (a noise introduced in a compression process of the image), a blur noise (a noise corresponding to image blur caused by a factor such as a vibration, a motion blur, or an optical blur in a photographing or transmission process of the image), a color noise (a noise difference between different color channels in the RGB image, for example, a color difference), or an environment noise (noise data generated from the environment in the image, for example, a light change, a shadow, or reflection.

In some embodiments, a manner of obtaining the first noise data includes at least one of the following several manners:

First, pre-obtain a noise data set, and adjust in various manners (e.g., randomly) at least one piece of noise data from the noise data set as the first noise data.

Second, perform a noise analysis on the first image, if the noise data exists in the first image, after the noise data is obtained, copy the noise data for a plurality of times, and use a copied result as the first noise data. For example, the first image includes 10 pixels, where a pixel 2 corresponds to the Gaussian noise, and the Gaussian noise, as the first noise data, is introduced to another pixel to change a pixel value thereof.

The foregoing manner of obtaining the first noise data is merely an adaptive example, which is not limited in this embodiment of this disclosure.

In some embodiments, the first noise data includes at least one type of noise data. When a plurality of types of noise data are included, the plurality of types of noise data belong to noise data of the same noise type or noise data of different noise types.

In some embodiments, a process of adding the first noise data to the first image is referred to as an image noise-adding processing process.

In some embodiments, the image noise-adding processing process is performed once or a plurality of times. When the image noise-adding processing process is performed for a plurality of times, a noise adding result of the first noise data added previously is used as to-be-processed data on which noise adding processing is currently performed. For example, the first noise data is added to an image a to obtain a noise-added image 1, which is used as a first image noise-adding processing process. The first noise data is added to the noise-added image 1 to obtain a noise-added image 2, which is used as a second image noise-adding processing process. When the image noise-adding processing ends, a noise-added image, obtained through the last noise-adding processing, is used as a noise-added image corresponding to the first image.

The noise data applied to the image noise-adding processing performed each time is the same or different. This is not limited herein.

For example, a specified step quantity is pre-obtained, and according to a quantity of noise adding times corresponding to the specified step quantity, the noise adding processing is performed on the first image.

Operation 220: Perform a semantic analysis on the first image to obtain semantic analysis data.

The semantic analysis data is configured to represent information of an image object in the first image.

In some embodiments, information of the image object includes at least one of information types such as an object direction, position distribution, a placement posture, and an object category of the image object in the first image.

The object direction refers to a direction in which the image object is located in the first image. For example, the image object in the first image includes a screw, and a screw head of the screw is oriented to a left side of the first image.

The position distribution refers to a position of the image object in the first image. For example, the image object in the first image includes a gear, and the gear is located in an upper left area of the first image.

The placement posture is a posture angle of the image object in the first image. For example, the image object in the first image includes a gear, a lower edge line of the first image is a horizontal line, and the gear rotates by 45 degrees anticlockwise from the horizontal line for display in the first image.

The object category refers to a classification situation corresponding to the image object. For example, an image object in the image a includes a gear, and an image object in an image b includes a nut. Since the gear and the nut belong to workpieces having different functions, object categories corresponding to the gear and the nut are different.

For example, a semantic analysis manner for obtaining the semantic analysis data includes at least one of the following manners:

First, obtain a semantic analysis model through pre-training, input the first image to the semantic analysis model, to output and obtain semantic analysis data corresponding to the first image.

Second, obtain a pixel value corresponding to each pixel in the first image, set a pixel value threshold, and use a pixel reaching the pixel value threshold as a pixel corresponding to the image object in the first image, to obtain pixel distribution of the image object in the first image. The position distribution of the image object in the first image may be obtained according to a pixel distribution situation, and an object contour of the image object may further be obtained according to a pixel distribution condition, to sequentially obtain the object category, the object direction, and the placement posture corresponding to the image object.

The foregoing semantic analysis manner is merely an example, and is not limited in this embodiment of this disclosure.

In the foregoing situation in which the semantic analysis model is obtained through the pre-training, in some embodiments, the semantic analysis model includes at least one of model types such as a word vector model, a bag-of-words model, a document vector model, a recurrent neural network (RNN) model (e.g., a long short-term memory network or a gated recurrent unit), a convolutional neural network (CNN) model, an attention mechanism model (e.g., a transformer model), and a pre-trained language model (e.g., a BERT model).

In some embodiments, the semantic analysis data refers to state information expressed by a single image object; or the semantic analysis data includes state information respectively corresponding to a plurality of image objects.

Operation 230: Perform, based on the semantic analysis data, the image denoising processing on the noise-added image, to obtain a second image.

In some embodiments, the image denoising processing refers to suppression or elimination of noise data in the noise-added image.

In some embodiments, the image denoising processing includes at least one of the following manners:

First, mean filtering: Replace each pixel in the image with an average value of pixels around the pixel.

Second, median filtering: Replace each pixel in the image with a median value of pixels around the pixel.

Third, Gaussian filtering: Perform blurring processing on the image by using a Gaussian function.

Fourth, wavelet transform: Convert the image to a wavelet domain, and remove the noise by performing threshold processing on a wavelet coefficient.

Fifth, total variation denoising: Optimize the image by using a total variation regularization model, to reduce the noise by minimizing a total variation of the image.

Sixth, non-local mean denoising: Estimate the noise by using a non-local similarity in the image and perform the denoising processing.

Seventh, deep learning-based method: Pre-train a neural network model, and perform learning and the denoising processing on the image by using the neural network model.

The foregoing image denoising processing manner is merely an example, and is not limited in this embodiment of this disclosure.

In some embodiments, the second image is an image generated by performing the image denoising processing on the noise-added image.

In some embodiments, the first image is the same as the second image, or the first image is different from the second image.

For example, if the first image is an image in which the image object has a defect part, the second image is an image corresponding to a situation in which the image object has no defect part in the first image.

In some embodiments, the image denoising processing is performed on the noise-added image through guidance of the semantic analysis data, and a complete image object in the first image is retained in the second image. Further, when the image object has the defect part in the first image, after denoising and noise adding, the defect part is repaired in the second image. In addition, under the guidance of the semantic analysis data, the image object in the second image is not different from the image object in the first image on the whole, such as the object category, an orientation, or a position. In this way, during similarity calculation in operation 240, only the defect part of the image object in the first image is a cause of an insufficient similarity, thereby effectively improving accuracy of recognizing the defect part.

Operation 240: Determine, based on the feature similarity between the first image and the second image, a defect recognition result corresponding to the first image.

The defect recognition result includes a defect condition of the image object.

For example, by comparing the feature similarity between the first image and the second image, an image similarity between the first image and the second image is determined. Since after the denoising, the second image is a non-defective image, a higher similarity indicates a higher possibility that the image object in the first image has no defect part. Otherwise, if the similarity is lower than a preset similarity threshold, the image object in the first image has the defect part.

In some embodiments, a first image feature representation corresponding to the first image is extracted, and a second image feature representation corresponding to the second image is extracted, to obtain a defect condition of the image object in the first image by calculating a feature similarity between the first image feature representation and the second image feature representation.

In some embodiments, a calculation manner of the feature similarity includes calculating a Euclidean distance, a cosine similarity, a correlation coefficient (calculating a correlation coefficient between two feature representations is dividing an oblique variance of the two feature representations by a product of standard deviations of the two feature representations, a value range of the correlation coefficient being [−1, 1], and a value closer to 1 representing a higher similarity), a Hamming distance, and a Pearson correlation coefficient (configured to measure a linear relationship between two feature representations, and calculated by dividing a covariance of two feature vectors by a product of standard deviations of the two feature vectors).

In some embodiments, the defect condition includes a position distribution condition in the first image of a part of the image object having the defect in the first image and a defect category (e.g., a dent, a crack, or a flaw) corresponding to the part having the defect.

In some embodiments, the defect condition is represented by a coordinate point and a numerical result, where the coordinate points are configured to indicate a coordinate point corresponding to the part having the defect, and the numerical result is configured to indicate the defect category corresponding to the part having the defect when different defect categories are predefined to be different numerical values; or the defect condition is represented by using a score graph, where the score graph is an image whose pixel size is the same as a pixel size of the first image, and a pixel channel value ranges from 0 to 1. 0 indicates that a pixel value of a pixel in the first image and a pixel value of the pixel in the second image are the same, and 1 indicates that the pixel value of the pixel in the first image and the pixel value of the pixel in the second image at the pixel are different. Therefore, a position corresponding to a pixel channel value 1 is the part having the defect.

In conclusion, according to the image processing method provided in this embodiment of this disclosure, after the first noise data is added to the first image to obtain the noise-added image, the semantic analysis is performed on the first image, to obtain the semantic analysis data corresponding to the information configured to represent the image object in the first image, so that the image denoising processing is performed on the noise-added image based on the semantic analysis data, to obtain the second image. Finally, the defect condition corresponding to the first image is determined by comparing the feature similarity between the first image and the second image. In other words, in a manner of obtaining the semantic analysis data by performing the semantic analysis on the first image, image denoising is guided by using the semantic analysis data. Since a semantic analysis object may reflect the information of the image object in the first image, during the image denoising, the image object in the noise-added image is clearly indicated, to avoid removing partial composition of the image object as the noise, to retain a complete image object in the second image to a greatest extent. In this way, when similarity matching is subsequently performed, only the defect part of the image object in the first image is a cause of the insufficient similarity, but a display problem of the image object in the second image caused by denoising is not a cause of the insufficient similarity, thereby improving accuracy and recognition efficiency of image object defect recognition.

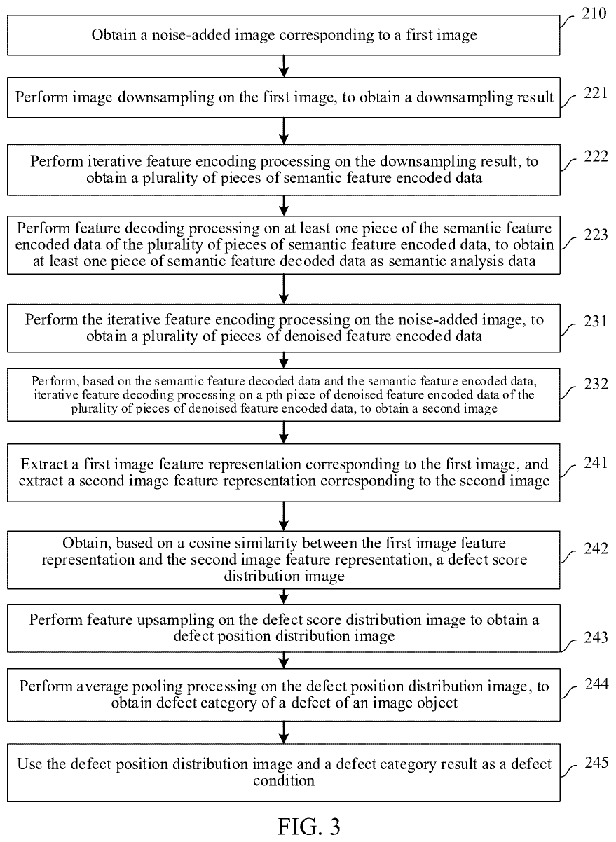

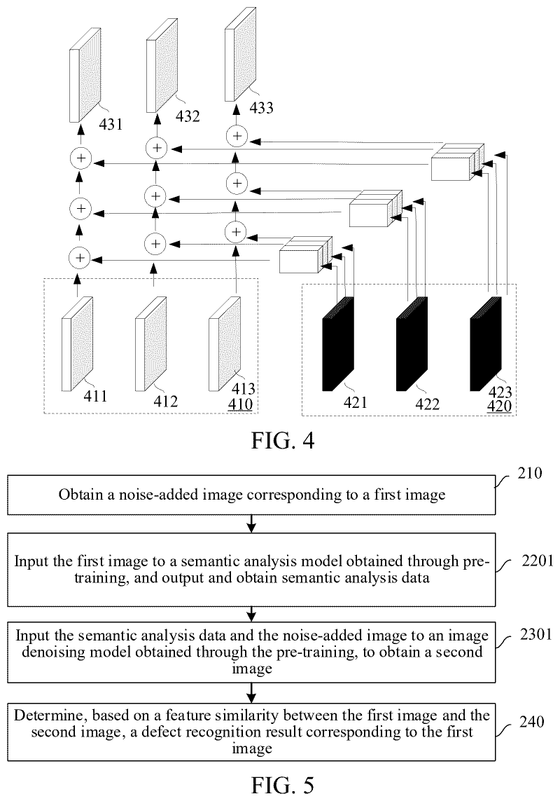

In an embodiment, the semantic analysis process includes encoding processing and decoding processing. For example, referring to FIG. 3, FIG. 3 is a flowchart of an image processing method according to an embodiment of this disclosure. In other words, operation 220 further includes operation 221 to operation 224, and operation 230 further includes operation 231 and operation 232. For example, as shown in FIG. 4, the method includes the following operations.

Operation 221: Perform image downsampling on a first image, to obtain a downsampling result.

For example, the image downsampling refers to an image configured to reduce an image resolution or reduce an image size.

In this embodiment, the first image is x₀∈ [symbol] ^{H×W×3}, where R represents a channel, H represents a height, and W represents a width.

Operation 222: Perform iterative feature encoding processing on the downsampling result, to obtain a plurality of pieces of semantic feature encoded data.

An (i+1)^{th} piece of semantic feature encoded data is obtained by performing feature encoding processing on an i^{th} piece of semantic feature encoded data, the plurality of pieces of semantic feature encoded data respectively correspond to different feature dimensions, and i is a positive integer.

For example, feature encoding processing is configured for an image processing manner of extracting key point information in an image.

In some embodiments, the feature encoding processing is performed on the downsampling result, to output and obtain semantic feature encoded data, and the semantic feature encoded data is used as input data for next feature encoding processing, so that a plurality of times of feature encoding processing are used as the iterative feature encoding processing.

For example, as a quantity of times of the feature encoding processing increases, a feature dimension corresponding to the semantic feature encoded data gradually decreases. For example, a feature dimension of a first layer of semantic feature encoded data obtained through first feature encoding processing is 32×32, a feature dimension of a second layer of semantic feature encoded data obtained by performing the feature encoding processing on the first layer of semantic feature encoded data is 16×16, and so on, until the last piece of semantic feature encoded data is obtained, and a feature dimension corresponding to the last piece of semantic feature encoded data is the smallest.

In this embodiment, an example in which the feature encoding processing is performed for four times as the iterative feature encoding processing process is used for description.

In some embodiments, after a fourth piece of semantic feature encoded data is obtained, the fourth piece of semantic feature encoded data is stored to the semantic data memory.

Operation 223: Perform feature decoding processing on at least one piece of semantic feature encoded data of the plurality of pieces of semantic feature encoded data, to obtain at least one piece of semantic feature decoded data as semantic analysis data.

For example, the feature decoding processing refers to an image processing process of restoring data, obtained through the feature encoding processing, to original data.

In this embodiment, after the plurality of pieces of semantic feature encoded data are obtained through the semantic feature encoding processing, iterative feature decoding processing is performed on one or more pieces of semantic feature encoded data, to finally obtain one or more pieces of semantic feature decoded data.

According to the foregoing semantic analysis process of encoding/decoding the first image, the obtained semantic feature encoded data can present clearer semantic information. For a feature dimension of the semantic feature encoded data, feature decoding processing more applicable to presenting a semantic of an image object can be selected, to obtain more accurate semantic analysis data.

For operation 223, in a possible implementation, feature fusion is performed on at least two pieces of semantic feature encoded data in the plurality of pieces of semantic feature encoded data, to obtain a first fused feature representation. The feature decoding processing is performed on the first fused feature representation, to obtain the semantic feature decoded data.

For example, after the plurality of pieces of semantic feature encoded data are obtained, the feature fusion is performed on at least two pieces of semantic feature encoded data of the plurality of pieces of semantic feature encoded data, to obtain the first fused feature representation.

In some embodiments, the at least two pieces of semantic feature encoded data are at least two adjacent pieces of semantic feature encoded data; or the at least two pieces of semantic feature encoded data are at least two non-adjacent pieces of semantic feature encoded data.

In some embodiments, the at least two pieces of semantic feature encoded data includes an n^{th} piece of semantic feature encoded data and an m^{th} piece of semantic feature encoded data, the n^{th} piece of semantic feature encoded data including k layers of first semantic subdata, the m^{th} piece of semantic feature encoded data including k layers of second semantic subdata, and n, m, and k being positive integers; convolution processing is separately performed on the k layers of second semantic subdata, to obtain k convolution processing results; the feature fusion is performed on the k convolution processing results and a j^{th} layer of first semantic subdata of the k layers of first semantic subdata, to obtain a j^{th} layer of first fused sub-feature, 0<j≤k, j being an integer; and the first fused feature representation is obtained based on the k layers of first fused sub-feature.

For example, for a single piece of semantic feature encoded data, the single piece of semantic feature encoded data includes a plurality of layers of semantic subdata. The feature fusion is performed on semantic subdata respectively corresponding to at least two pieces of semantic feature encoded data, to obtain the first fused feature representation.

In this embodiment, an example in which the at least two pieces of semantic feature encoded data are implemented as a third piece of semantic feature encoded data and a fourth piece of semantic feature encoded data is used for description. In other words, n=3 and m=4.

In this embodiment, an example in which the third piece of semantic feature encoded data includes three layers of first semantic subdata, and the fourth piece of semantic feature encoded data includes three layers of second semantic subdata is used for description, that is, k=3.

In a process of performing the feature fusion on the third piece of semantic feature encoded data and the fourth piece of semantic feature encoded data, the convolution processing is performed on the three layers of second semantic subdata in the fourth piece of semantic feature encoded data, to obtain convolution processing results respectively corresponding to the three layers of second semantic subdata.

After the three convolution processing results are obtained, feature concatenation is performed on a first convolution processing result and the third piece of semantic feature encoded data, to obtain a first layer of first fused sub-feature. The feature concatenation is performed on a second convolution processing result and the first layer of first fused sub-feature, to obtain a second layer of first fused sub-feature. The three layers of first fused sub-features are obtained when the feature fusion is completed. The three layers of first fused sub-features are used as the first fused feature representation, and are denoted as

$${𝒬}_{i} = {𝒫}_{i} + {\sum }_{j = 1}^{J} ℱ ( {ℋ}_{j} ) .$$

J=3 indicates that three layers of third piece of semantic feature encoded data are used, [symbol] ᵢ represents a low-scale output feature map (e.g., each layer of fused sub-feature) in the third piece of semantic feature encoded data, [symbol] represents a high-scale output feature map (e.g., a convolution processing result) in the fourth piece of semantic feature encoded data, and [symbol] ( [symbol] ⱼ) represents a convolution module including a 3×3 convolution layer, a normalization layer, and an activation layer.

For example, referring to FIG. 4, FIG. 4 is a schematic diagram of a feature fusion process according to an embodiment of this disclosure. As shown in FIG. 4, in a process of performing the feature fusion on a third piece of semantic feature encoded data 410 and a fourth piece of semantic feature encoded data 420, using a first layer of second semantic subdata 421 in the fourth piece of semantic feature encoded data 420 as an example, the convolution processing is performed on the first layer of second semantic subdata 421 in the fourth piece of semantic feature encoded data 420, the feature concatenation is performed on an obtained convolution result and a first layer of first semantic subdata 411, to obtain a first fusion result, and the feature concatenation is performed on a convolution result obtained by performing the convolution processing on a second layer of second semantic subdata 422 and the first fusion result, to obtain a second fusion result. The feature concatenation is performed on a convolution result obtained by performing the convolution processing on a third layer of second semantic subdata 423 and the second fusion result, to finally obtain a first layer of first fused sub-feature 431. Finally, the first layer of first fused sub-feature 431, a second layer of first fused sub-feature 432, and a third layer of first fused sub-feature 433 respectively corresponding to the three layers of second semantic subdata are used as the first fused feature representation.

Since different pieces of semantic feature encoded data have different feature dimensions, by fusing the plurality of pieces of semantic feature encoded data, the first fused feature representation is obtained. The first fused feature representation can carry features of image objects in a plurality of feature dimensions, and has more useful information, thereby improving an expression capability and accuracy of the semantic feature encoded data for the image object.

In some embodiments, semantic segmentation is performed on target semantic feature encoded data of the plurality of pieces of semantic feature encoded data, to obtain a first semantic segmented feature, the first semantic segmented feature being configured to represent a pixel classification result of the first image.

For example, the semantic segmentation refers to classifying a pixel in an input image.

In this embodiment, after four pieces of semantic feature encoded data are obtained, the fourth piece of semantic feature encoded data is inputted to a first semantic segmentation model obtained through pre-training for the semantic segmentation, to output and obtain the first semantic segmented feature configured to represent a classification result of each pixel in the first image. For example, a pixel a and a pixel b are pixels corresponding to an object 1 in the first image, and a pixel c, a pixel d, and a pixel e are pixels corresponding to an object 2 in the first image.

In this embodiment, the first semantic segmentation model is implemented as a spatial gridding module (SGM), and a module structure corresponding to the first semantic segmentation model has three layers, including a layer of ResnetBlock, a layer of spatial transformer module, and a layer of ResnetBlock. The ResnetBlock is a basic construction unit in a residual network, and is configured to learn an image feature. The ResnetBlock includes two convolution layers, which include a residual connection. The spatial transformer is a module configured to learn image geometrical transformation. The spatial transformer learns how to perform the geometrical transformation, such as translation, rotation, and zooming, on the input image, thereby improving robustness of a network to the geometrical transformation of an image.

In a possible implementation, the operation 230: performing, based on the semantic analysis data, image denoising processing on the noise-added image, to obtain a second image includes the following operations:

Operation 231: Perform the iterative feature encoding processing on the noise-added image, to obtain a plurality of pieces of denoised feature encoded data.

For example, a process of performing the image denoising processing on the noise-added image also includes two processes: the feature encoding processing and the feature decoding processing.

In this embodiment, an example in which a feature encoding processing process is iteratively performed for four times is used for description. First, the feature encoding process is performed on the noise-added image to obtain a first piece of denoised feature encoded data. Second, the feature encoding processing is performed on the first piece of denoised feature encoded data to obtain a second piece of denoised feature encoded data. Then, the feature encoding processing is performed on the second piece of denoised feature encoded data to obtain a third piece of denoised feature encoded data. Finally, the feature encoding processing is performed on the third piece of denoised feature encoded data to obtain a fourth piece of denoised feature encoded data.

In some embodiments, the feature fusion is performed on a q^{th} denoised feature encoded data and the downsampling result, to obtain a second fused feature representation; and the iterative feature encoding processing is performed on the second fused feature representation, to obtain the plurality of pieces of semantic feature encoded data, where q<p, and q is a positive integer.

In this embodiment, after the feature encoding processing is performed on the noise-added image to obtain the first piece of denoised feature encoded data, the feature fusion is performed on the first piece of denoised feature encoded data and a downsampling result corresponding to the first image, to obtain the second fused feature representation, and the foregoing iterative feature encoding processing is performed on the second fused feature representation, to obtain the foregoing plurality of pieces of semantic feature encoded data.

Operation 232: Perform, based on the semantic feature decoded data and the semantic feature encoded data, the iterative feature decoding processing on a p^{th} piece of denoised feature encoded data of the plurality of pieces of denoised feature encoded data, to obtain the second image.

For example, after the p^{th} piece of denoised feature encoded data is obtained, the iterative feature decoding processing is performed on the semantic feature encoded data and/or the semantic feature decoded data obtained in the foregoing operations and the p^{th} piece of denoised feature encoded data, to obtain the denoised feature decoded data. After the iterative feature decoding processing is performed on the denoised feature decoded data, the second image is finally obtained.

In this embodiment, after the last piece of denoised feature encoded data is obtained, the last piece of denoised feature encoded data and the fourth piece of semantic feature encoded data are stored, to obtain fused data. The feature decoding processing is performed on the semantic feature decoded data and the fused data, to obtain a first piece of denoised feature decoded data. In addition, the feature decoding processing is performed on the semantic feature decoded data, the fourth piece of denoised feature encoded data, and the first piece of denoised feature decoded data, to obtain a second piece of denoised feature decoded data. In this way, the iterative feature decoding processing is performed until the second image is obtained.

In some embodiments, the iterative feature decoding processing is performed based on the semantic feature decoded data for p times on the p^{th} piece of denoised feature encoded data, to obtain second noise data, the second noise data being configured to indicate a prediction result of the first noise data; data denoising processing is performed on the noise-added image based on the second noise data, to obtain a data denoised feature, the data denoised feature being configured to represent an image feature representation corresponding to an image obtained from the noise-added image after the second noise data is removed; and image decoding processing is performed on the data denoised feature, to obtain the second image.

In some embodiments, the semantic segmentation is performed on the p^{th} piece of denoised feature encoded data, to obtain a second semantic segmented feature, the second semantic segmented feature being configured to represent a pixel classification result of the noise-added image; the feature concatenation is performed on the first semantic segmented feature and the second semantic segmented feature, to obtain a semantic concatenated feature; and the iterative feature decoding processing is performed on the semantic concatenated feature based on the semantic feature decoded data and the p^{th} piece of denoised feature encoded data, to obtain the second noise data.

In this embodiment, an example in which p is 4 is used as an example for description. After the fourth piece of denoised feature encoded data is obtained, the fourth piece of denoised feature encoded data is inputted to a second semantic segmentation model obtained through the pre-training for the semantic segmentation, to output and obtain a second semantic segmented feature. The second semantic segmented feature is configured to represent a classification result corresponding to each pixel in the noise-added image. A model structure of the second semantic segmentation model is consistent with a model structure of the first semantic segmentation model. In other words, the second semantic segmentation model, that is, the spatial gridding module (SGM), also includes the layer of ResnetBlock, the layer of spatial transformer, and the layer of ResnetBlock.

In this embodiment, after the second semantic segmented feature is obtained, the feature concatenation is performed on the first semantic segmented feature and the second semantic segmented feature, to obtain the semantic concatenated feature.

In this embodiment, the iterative feature decoding processing is performed on the semantic concatenated feature based on the semantic feature decoded data and the p^{th} piece of denoised feature encoded data, to obtain the second noise data.

In this embodiment, an example in which the feature decoding processing process is iteratively performed for four times is used. After the iterative feature decoding processing is performed on the fourth piece of denoised feature encoded data for four times, the second noise data Ee is obtained, and the data denoising processing is performed on the second noise data, to obtain a data denoised feature \hat{z}.

In some embodiments, the first noise data is the same as the second noise data; or the first noise data and the second noise data are different.

In this embodiment, based on the second noise data, the data denoising processing is performed on the noise-added image by using a pre-obtained denoising formula, to obtain the data denoised feature. The formula is pe (x₀|xₜ₋₁), where x₀ represents the first image, and xₜ₋₁ represents a noise-added subimage obtained through the image noise-adding processing in a (t−1)^{th} operation.

In this embodiment, after the data denoised feature is obtained, the data denoised feature is outputted to an image decoder obtained through the pre-training for the image decoding processing, to obtain the second image. The second image is denoted as \hat{x}₀.

When the image denoising processing is performed on the noise-added image, semantic feature decoded data used as the semantic analysis data is used as a guide for image denoising, so that the image object is considered during the image denoising, to avoid incorrect denoising by recognizing the image object as noise, thereby improving image denoising precision.

In a possible implementation, the operation 240: determining, based on the feature similarity between the first image and the second image, a defect recognition result corresponding to the first image includes the following operations:

Operation 241: Extract a first image feature representation corresponding to the first image, and extract a second image feature representation corresponding to the second image.

For example, a defect condition of the image object includes a position distribution condition and a defect category of a defect of the image object.

For example, the first image and the second image are jointly inputted to the same pre-trained feature extraction model in a value feature space, to extract the first image feature representation and a second image feature representation corresponding to the first image.

In some embodiments, the first image feature representation includes feature representations of a plurality of different feature dimensions, and the second image feature representation also includes feature representations of a plurality of different feature dimensions. A feature dimension distribution condition of the first image feature representation is consistent with a feature dimension distribution condition of the second image feature representation.

In this embodiment, the pre-obtained feature extraction model is implemented as a convolution neural network resnet50.

Operation 242: Obtain, based on a cosine similarity between the first image feature representation and the second image feature representation, a defect score distribution image.

A pixel value in the defect score distribution image is configured to indicate a difference between a pixel value in the first image and a pixel value in the second image.

In this embodiment, defect scores in different feature dimensions of the first image feature representation and the second image feature representation are calculated according to a cosine similarity formula, to obtain the defect score distribution image. For the cosine similarity formula, refer to the following formula 1.

$${ℳ}^{n} ( {x}_{0} , \text{?} ) = 1 - \frac{{( {Ψ}^{n} ( {x}_{0} , \text{?} ) )}^{T} \cdot {Ψ}^{n} ( {x}_{0} , \text{?} )}{‖ {Ψ}^{n} ( {x}_{0} , \text{?} ) ‖ ‖ {Ψ}^{n} ( {x}_{0} , \text{?} ) ‖} \qquad Formula 1$$

In formula 1, n represents an image feature representation corresponding to an n^{th} feature dimension.

For example, the defect score distribution image is a grayscale image with a same pixel size as the first image, and an obtained pixel channel value range corresponding to the defect score distribution image includes 0 to 1. When the channel value is 0, a pixel value in the first image is the same as a pixel value at the same position in the second image, and when the channel value is 1, the pixel value in the first image is different from the pixel value at the same position in the second image.

Operation 243: Perform feature upsampling on the defect score distribution image to obtain a defect position distribution image.

The defect position distribution image is configured to indicate a position distribution condition in which the image object has a defect.

For example, after the defect score distribution image is obtained, the feature upsampling is performed on the defect score distribution image, and a quantity of applied feature dimensions is selected, to obtain the defect position distribution image. For a feature upsampling process, refer to the following formula 2.

$$𝒮 = {\sum }_{n ∈ N} {σ}_{n} {ℳ}^{n} ( {x}_{0} , \text{?} ) \qquad Formula 2$$

In formula 2, σₙ represents an upsampling rate, and N represents a quantity of used feature dimensions.

Operation 244: Perform average pooling processing on the defect position distribution image, to obtain the defect category of the defect of the image object.

For example, after the defect position distribution image is obtained, global average pooling processing is performed on the defect position distribution image, and a maximum value obtained through processing is used as a defect category result.

Operation 245: Use the defect position distribution image and the defect category result as the defect condition.

Finally, the defect position distribution image and the defect category result are used as the defect recognition result.

In some embodiments, a defect score of the first image and the second image at an RGB layer may be further calculated, and the defect score, the defect position distribution image, and the defect category result are combined as the defect condition.

In conclusion, according to the image processing method provided in this embodiment of this disclosure, after the first noise data is added to the first image to obtain the noise-added image, the semantic analysis is performed on the first image, to obtain the semantic analysis data corresponding to the information configured to represent the image object in the first image, so that the image denoising processing is performed on the noise-added image based on the semantic analysis data, to obtain the second image. Finally, the defect condition corresponding to the first image is determined by comparing the feature similarity between the first image and the second image. In other words, the semantic analysis is performed on the first image to obtain the semantic analysis data, so that the semantic analysis data guides the image denoising, to ensure that an image object in the second image after denoising is the same as an image object in the first image. Further, feature similarities are compared to determine a defect condition of the image object in the first image, thereby improving accuracy and recognition efficiency of image object defect recognition.

In this embodiment, performing the feature encoding processing and the feature decoding processing on the first image can make an output result include state information of the image object in the first image, thereby improving accuracy of the semantic analysis.

In this embodiment, after performing the feature fusion on at least two pieces of semantic feature encoded data, performing the feature decoding processing on the at least two pieces of semantic feature encoded data can improve information richness of finally obtained semantic feature decoded data.

In this embodiment, after the two pieces of semantic feature encoded data are layered, performing the feature fusion through the convolution processing can improve decoding accuracy of the semantic feature decoded data.

In this embodiment, performing the iterative feature encoding processing on the noise-added image, and performing, based on the semantic feature decoded data, the iterative feature decoding processing on the denoised feature encoded data to obtain the second image can improve consistency between the second image and the first image.

In this embodiment, after the feature fusion is performed on the denoised feature encoded data and the downsampling result, the feature encoding processing is performed on the denoised feature encoded data and the downsampling result, to improve the accuracy of the semantic analysis.

In an embodiment, the foregoing image object recognition process is implemented in a deep learning-based manner. For example, referring to FIG. 5, FIG. 5 is a flowchart of an image processing method according to an embodiment of this disclosure. As shown in FIG. 5, the method includes the following operations.

Operation 2201: Input a first image to a semantic analysis model obtained through pre-training, to output and obtain semantic analysis data.

For example, the semantic analysis model includes an encoder and a decoder, respectively applied to performing the foregoing feature encoding processing and feature decoding processing, to obtain the semantic analysis data.

The semantic analysis model includes a plurality of semantic encoding modules sequentially arranged, a first semantic analysis model, and a semantic decoding module. Image denoising data is inputted to a first semantic encoding module to output and obtain a first piece of semantic feature encoded data, and the first piece of semantic feature encoded data is inputted to a second semantic encoding module to output and obtain a second piece of semantic feature encoded data. In this way, iterative feature encoding processing is performed, to finally obtain a plurality of pieces of semantic feature encoded data.

A fourth piece of semantic feature encoded data is inputted to a first semantic segmentation model obtained through pre-training, to output and obtain a first semantic segmented feature.

A first fused feature representation, obtained by performing feature fusion on at least two pieces of semantic feature encoded data, is inputted to a decoding module, to output and obtain semantic feature decoded data.

The semantic decoding module is implemented as a semantic guided encoding block (SGEB), and a network structure of the semantic decoding module includes three layers of ResnetBlocks.

The semantic feature encoded data and the semantic feature decoded data are used as semantic analysis data.

Operation 2301: Input the semantic analysis data and a noise-added image to an image denoising model obtained through the pre-training, to obtain a second image.

For example, the image denoising model includes a plurality of denoising encoding modules sequentially arranged and a plurality of denoising decoding modules sequentially arranged, respectively applied to performing the foregoing denoised feature encoding processing and the foregoing denoised feature decoding processing, to obtain the second image.

An image denoising result is inputted to a first denoising encoding module to output and obtain a first piece of denoised feature encoded data, and the first piece of denoised feature encoded data is inputted to a second denoising encoding module to output and obtain a second piece of denoised feature encoded data. In this way, iterative feature encoding processing is performed, to finally obtain the last piece of denoised feature encoded data.

The last piece of denoised feature encoded data, the fourth piece of semantic feature encoded data, and the semantic feature decoded data are inputted to a first denoising decoding module to output and obtain a first piece of denoised feature decoded data. The first piece of denoised feature decoded data is inputted to a second denoising decoding module to output and obtain a second piece of denoised feature decoded data, to perform iterative feature decoding processing, to obtain second noise data. Data denoising processing is performed based on the second noise data, to finally obtain the second image. For the second noise data, refer to formula 3.

$$𝒢 = {𝒟}_{S D} ( {ℳ}_{S D} ( {ℰ}_{S D} ( {z}_{t} ) ) + {ℳ}_{S G} ( {ℰ}_{S D} ( z + 𝒞 ( {x}_{0} ) ) ) ) + {𝒟}_{S G j} ( {ℳ}_{S G} ( {ℰ}_{S D} ( z + 𝒞 ( {x}_{0} ) ) ) ) \qquad Formula 3$$

[symbol] _{SD} represents a decoding module of the image denoising model, [symbol] _{SD} represents a denoised data storage module of the image denoising model, Esp represents an encoding module in the image denoising model, [symbol] _{Sg} represents a semantic data storage module in the semantic analysis model, [symbol] (⋅) represents a convolution neural network layer, and [symbol] _{SGj} represents a decoding module of the semantic analysis model.

The semantic encoding module is implemented as a semantic guided decoder block (SGDB) also including the three layers of ResnetBlocks. The denoising decoding module includes a layer of ResnetBlock, a layer of spatial transformer, the layer of ResnetBlock, and an upsample. Therefore, a three-layer output result (the fourth piece of semantic feature encoded data) of the fourth semantic encoding module is added to a three-layer output result (the semantic feature decoded data) of the semantic decoding module, and then connected to a corresponding ResnetBlock of the first denoising decoding module, and the fourth piece of denoised feature encoded data is inputted to the first denoised decoding module, to perform denoising decoding processing, to obtain the first piece of denoised feature decoded data.

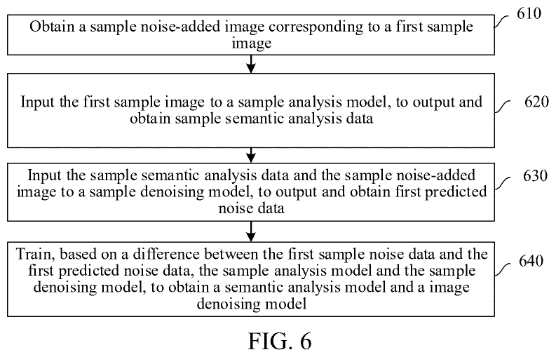

The following describes a training process of the semantic analysis model and the image denoising model. As shown in FIG. 6, a flowchart of a training process of an image recognition method according to an embodiment of this disclosure is currently shown. As shown in FIG. 6, the method includes the following operations.

Operation 610: Obtain a sample noise-added image corresponding to a first sample image.

The sample noise-added image is a result obtained by adding first sample noise data to the first sample image.

For example, first, the first sample image is obtained for training, the first sample image is inputted to a pre-trained encoder, to obtain a hidden variable representation, and noise data is added to the hidden variable representation in various manners (e.g., randomly), to obtain the sample noise-added image.

For example, the first sample image is a non-defective sample image.

Operation 620: Input the first sample image to a sample analysis model, to output and obtain sample semantic analysis data.

The first sample image is inputted to the sample analysis model to perform the feature encoding processing, the feature decoding processing, and the feature fusion, to obtain the semantic analysis data.

Operation 630: Input the sample semantic analysis data and the sample noise-added image to a sample denoising model, to output and obtain first predicted noise data.

In a process of inputting the noise-added image to the sample denoising model for image denoising processing, the semantic analysis data is inputted to the sample denoising model, to output and obtain the first predicted noise data.

Operation 640: Train, based on a difference between the first sample noise data and the first predicted noise data, the sample analysis model and the sample denoising model, to obtain the semantic analysis model and the image denoising model.

The sample analysis model and the sample denoising model are trained based on a distance loss value L2 between the first sample noise data and the first predicted noise data, to obtain the semantic analysis model and the image denoising model.

In conclusion, according to the image processing method provided in this embodiment of this disclosure, after the first noise data is added to the first image to obtain the noise-added image, the semantic analysis is performed on the first image, to obtain the semantic analysis data corresponding to the information configured to represent the image object in the first image, so that the image denoising processing is performed on the noise-added image based on the semantic analysis data, to obtain the second image. Finally, the defect condition corresponding to the first image is determined by comparing the feature similarity between the first image and the second image. In other words, the semantic analysis is performed on the first image to obtain the semantic analysis data, so that the semantic analysis data guides the image denoising, to ensure that an image object in the second image after denoising is the same as an image object in the first image. Further, feature similarities are compared to determine a defect condition of the image object in the first image, thereby improving accuracy and recognition efficiency of image object defect recognition.

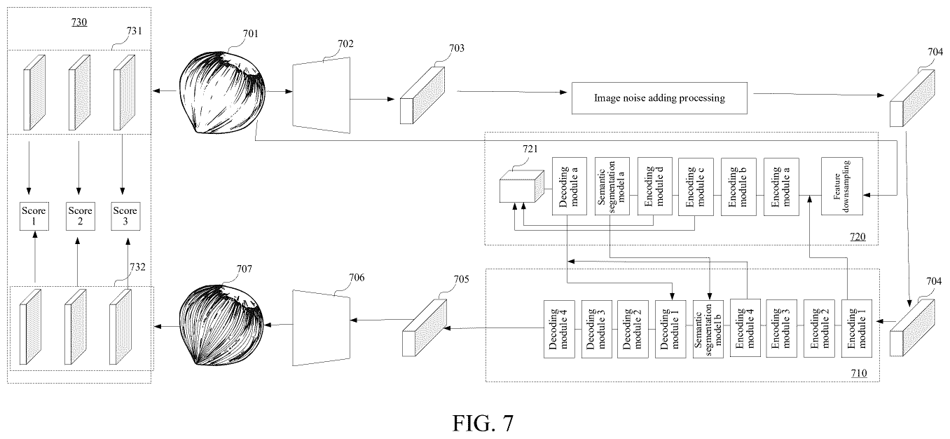

For example, refer to FIG. 7. FIG. 7 is a schematic diagram of an image processing method according to an embodiment of this disclosure. As shown in FIG. 7, the method includes the following processes.

A first image 701 is obtained, the first image 701 is inputted to an encoder 702, to obtain a hidden variable representation 703, and image noise-adding processing is performed on the hidden variable representation 703, to obtain a noise-added image 704.

The noise-added image 704 is inputted to an image denoising model 710 for the image denoising processing. Meanwhile, the first image 701 is inputted to a semantic analysis model 720 for semantic analysis.

In a semantic analysis process, feature downsampling is performed on the first image 701, to obtain a downsampling result. In this case, in an image denoising processing process, the first piece of denoised feature encoded data, obtained by an encoding module 1 of an encoder of the image denoising model 710 by performing the feature encoding processing, and the downsampling result are inputted to an encoding module a of the semantic analysis model 720 for the feature encoding processing. Obtained data passes through an encoding module b, an encoding module c, and an encoding module d. Semantic feature encoded data respectively outputted by the encoding module c and the encoding module d is inputted to a feature fusion module 721 for feature fusion, to obtain the first fused feature representation. The first fused feature representation is inputted to the decoding module a, to obtain the semantic feature decoded data. In addition, the fourth semantic feature encoded data outputted by the encoding module d is inputted to a semantic segmentation model a, to obtain the first semantic segmented feature.

The encoding module a, the encoding module b, the encoding module c, and the encoding module d are implemented as four semantic guided encoder modules (SGEB). Therefore, the encoding module a corresponds to an SGEB1, the encoding module b corresponds to an SGEB2, the encoding module c corresponds to an SGEB3, and the encoding module d corresponds to an SGEB4. A network structure of the SGEB includes the layer of ResnetBlock, the layer of spatial transformer, the layer of ResnetBlock, and a downsample.

The semantic segmentation model a is implemented as an SGM model.

The decoding module a is implemented as the semantic guided decoder block (SGDB).

In the image denoising processing process, iterative feature encoding processing is performed on the encoding module 1, the encoding module 2, the encoding module 3, and the encoding module 4. A fourth piece of denoised feature encoded data obtained through the encoding module 4 is inputted to a semantic segmentation model b, to obtain a second semantic segmented feature. The feature fusion is performed on the first semantic segmented feature and the second semantic segmented feature, and the fourth piece of denoised feature encoded data is inputted to the decoding module 1 for decoding, to obtain the first piece of denoised feature encoded data. The first piece of denoised feature encoded data and the first fused feature representation are jointly inputted to the decoding module 2 for feature decoding, and then sequentially pass through the decoding module 3 and the decoding module 4, to obtain second noise data.

The encoding module 1, the encoding module 2, the encoding module 3, and the encoding module 4 are implemented as four stable diffusion encoder blocks (SDEB). Therefore, the encoding module 1 corresponds to an SDEB1, the encoding module 2 corresponds to an SDEB2, the encoding module 3 corresponds to an SDEB3, and the encoding module 4 corresponds to an SDEB4.

The decoding module 1, the decoding module 2, the decoding module 3, and the decoding module 4 are implemented as four stable diffusion decoder blocks (SDDB). Therefore, the decoding module 1 corresponds to an SDDB1, the decoding module 2 corresponds to an SDDB2, the decoding module 3 corresponds to an SDDB3, and the decoding module 4 corresponds to an SDDB4.

The data denoising processing is performed on the second noise data to obtain a denoised feature representation 705. The denoised feature representation 705 is inputted to a decoder 706 to obtain a second image 707. The first image 701 and the second image 707 are inputted to a feature space 730, to obtain a first image feature representation 731 and a second image feature representation 732 through extraction. Finally, a defect condition is obtained based on a cosine similarity between the first image feature representation 731 and the second image feature representation 732.

For example, referring to FIG. 8, FIG. 8 is a comparison diagram of image processing method effects according to an embodiment of this disclosure. As shown in FIG. 8, a first image 801 is a to-be-detected input image, an image 802 is an image obtained through denoising processing after noise-adding processing by using a related technology, an image 803 is an image obtained through processing by using a solution of this disclosure, and an image 804 is a contour reference image. FIG. 8 shows that accuracy of an image processing result of the image processing solution of this disclosure is higher than accuracy corresponding to an image obtained through processing in the related technology.

In conclusion, according to the image processing method provided in this embodiment of this disclosure, after the first noise data is added to the first image to obtain the noise-added image, the semantic analysis is performed on the first image, to obtain the semantic analysis data corresponding to the information configured to represent the image object in the first image, so that the image denoising processing is performed on the noise-added image based on the semantic analysis data, to obtain the second image. Finally, the defect condition corresponding to the first image is determined by comparing the feature similarity between the first image and the second image. In other words, the semantic analysis is performed on the first image to obtain the semantic analysis data, so that the semantic analysis data guides the image denoising, to ensure that an image object in the second image after denoising is the same as an image object in the first image. Further, feature similarities are compared to determine a defect condition of the image object in the first image, thereby improving accuracy and recognition efficiency of image object defect recognition.

This technical solution provides, based on a diffusion model framework, a multi-type defect detection method, improves a related diffusion model denoising network framework, adds a semantic guiding network, relieves problems of a category error and a semantic error presented when the related diffusion model deals with a multi-type defect detection task, reconstructs a large-area defect area while maintaining consistency of semantic information of an input image and semantic information of a reconstructed image, and can effectively reconstruct defects of different types to become normal samples. In addition, by extracting the input image and the reconstructed image through a feature extraction network, defects can be effectively detected and located, and the multi-type defect detection method can deal with detection and location of multi-type defects in an actual industrial scenario.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

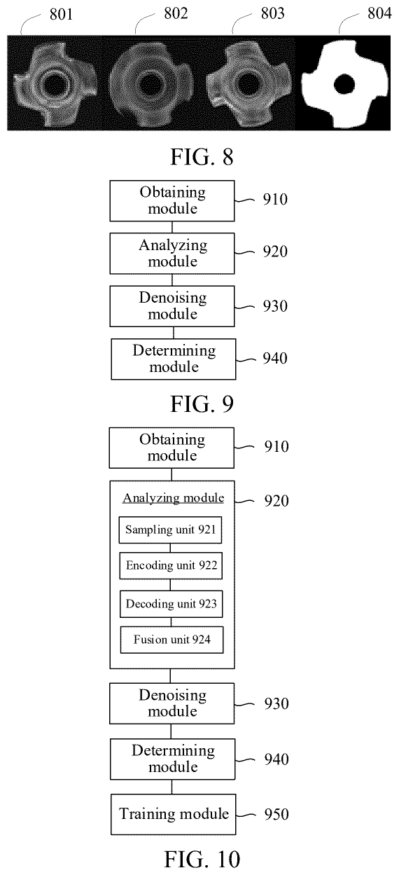

FIG. 9 is a structural block diagram of an image processing apparatus according to an embodiment of this disclosure. As shown in FIG. 9, the apparatus includes the following parts:
an obtaining module 910, configured to obtain a noise-added image corresponding to a first image, the noise-added image being a result obtained by adding first noise data to the first image, and the first image including an image object;
an analyzing module 920, configured to perform a semantic analysis on the first image to obtain semantic analysis data, the semantic analysis data being configured to represent information of the image object in the first image;
a denoising module 930, configured to perform, based on the semantic analysis data, image denoising processing on the noise-added image, to obtain a second image; and
a determining module 940, configured to determine, based on a feature similarity between the first image and the second image, a defect recognition result corresponding to the first image, the defect recognition result including a defect condition of the image object.

In some embodiments, as shown in FIG. 10, the analyzing module 920 includes:
a sampling unit 921, configured to perform image downsampling on the first image, to obtain a downsampling result;
an encoding unit 922, configured to perform iterative feature encoding processing on the downsampling result, to obtain a plurality of pieces of semantic feature encoded data, an (i+1)^{th} piece of semantic feature encoded data being obtained by performing feature encoding processing on an i^{th} piece of semantic feature encoded data, the plurality of pieces of semantic feature encoded data respectively corresponding to different feature dimensions, and i being a positive integer; and
a decoding unit 923, configured to perform feature decoding processing on at least one piece of semantic feature encoded data of the plurality of pieces of semantic feature encoded data, to obtain at least one piece of semantic feature decoded data as the semantic analysis data.

In some embodiments, the analyzing module 920 further includes:
a fusion unit 924, configured to perform feature fusion on at least two pieces of semantic feature encoded data of the plurality of pieces of semantic feature encoded data, to obtain a first fused feature representation; and
the decoding unit 923, configured to perform the feature decoding processing on the first fused feature representation, to obtain the semantic feature decoded data as the semantic analysis data.

In some embodiments, the at least two pieces of semantic feature encoded data includes an n^{th} piece of semantic feature encoded data and an m^{th} piece of semantic feature encoded data, the n^{th} piece of semantic feature encoded data including k layers of first semantic subdata, the m^{th} piece of semantic feature encoded data including k layers of second semantic subdata, and n, m, and k being positive integers; and
the fusion unit 924 is configured to: separately perform the convolution processing on the k layers of second semantic subdata, to obtain k convolution processing results; perform the feature fusion on the k convolution processing results and a j^{th} layer of first semantic subdata, to obtain a j^{th} layer of first fused sub-feature, 0<j≤k, j being an integer; and obtain, based on the k layers of first fused sub-feature, the first fused feature representation.

In some embodiments, the denoising module 930 is further configured to: perform the iterative feature encoding processing on the noise-added image, to obtain the plurality of pieces of denoised feature encoded data; and perform, based on the semantic feature decoded data and the semantic feature encoded data, the iterative feature decoding processing on a p^{th} piece of denoised feature encoded data of the plurality of pieces of denoised feature encoded data, to obtain the second image, p being a positive integer.

In some embodiments, the denoising module 930 is further configured to perform the feature fusion on a q^{th} piece of denoised feature encoded data and the downsampling result, to obtain a second fused feature representation, q<p, q being a positive integer; and perform the iterative feature encoding processing on the second fused feature representation, to obtain the plurality of pieces of semantic feature encoded data.

In some embodiments, the denoising module 930 is further configured to: perform, based on the semantic feature decoded data and the semantic feature encoded data, the iterative feature decoding processing on the p^{th} piece of denoised feature encoded data, to obtain second noise data, the second noise data being configured to indicate a prediction result of the first noise data; perform, based on the second noise data, data denoising processing on the noise-added image, to obtain a data denoised feature, the data denoised feature being configured to represent an image feature representation corresponding to an image obtained from the noise-added image after the second noise data is removed; and perform image decoding processing on the data denoised feature, to obtain the second image.

In some embodiments, the denoising module 930 is further configured to: perform semantic segmentation on target semantic feature encoded data of the plurality of pieces of semantic feature encoded data, to obtain a first semantic segmented feature, the first semantic segmented feature being configured to represent a pixel classification result of the first image; perform the semantic segmentation on the p^{th} piece of denoised feature encoded data, to obtain a second semantic segmented feature, the second semantic segmented feature being configured to represent a pixel classification result of the noise-added image; perform feature concatenation on the first semantic segmented feature and the second semantic segmented feature, to obtain a semantic concatenated feature; and perform, based on the semantic feature decoded data and the p^{th} piece of denoised feature encoded data, the iterative feature decoding processing on the semantic concatenated feature, to obtain the second noise data.

In some embodiments, the defect condition of the image object includes a position distribution condition and a defect category of a defect of the image object;
the determining module 940 is further configured to: extract a first image feature representation corresponding to the first image, and extracting a second image feature representation corresponding to the second image; obtain, based on a cosine similarity between the first image feature representation and the second image feature representation, a defect score distribution image, a pixel value in the defect score distribution image being configured to indicate a difference between a pixel value in the first image and a pixel value in the second image; perform feature upsampling on the defect score distribution image, to obtain a defect position distribution image, the defect position distribution image being configured to indicate the position distribution condition in which the image object has the defect; perform average pooling processing on the defect position distribution image, to obtain the defect category of the defect of the image object; and use the defect position distribution image and the defect category as the defect recognition result.

In some embodiments, the analyzing module 920 is further configured to input the first image to a semantic analysis model obtained through pre-training, to output and obtain the semantic analysis data; and
the denoising module 930 is further configured to input the semantic analysis data and the noise-added image to an image denoising model obtained through the pre-training, to obtain the second image.

In some embodiments, the apparatus further includes:
a training model 950, configured to obtain a sample noise-added image corresponding to a first sample image, the sample noise-added image being a result obtained by adding first sample noise data to the first sample image; input the first sample image to a sample analysis model, to output and obtain sample semantic analysis data; input the sample semantic analysis data and the sample noise-added image to a sample denoising model, to output and obtain first predicted noise data; and train, based on a difference between the first sample noise data and the first predicted noise data, the sample analysis model and the sample denoising model, to obtain the semantic analysis model and the image denoising model.

In conclusion, according to the image processing apparatus provided in this embodiment of this disclosure, after the first noise data is added to the first image to obtain the noise-added image, the semantic analysis is performed on the first image, to obtain the semantic analysis data corresponding to the information configured to represent the image object in the first image, so that the image denoising processing is performed on the noise-added image based on the semantic analysis data, to obtain the second image. Finally, the defect condition corresponding to the first image is determined by comparing the feature similarity between the first image and the second image. In other words, the semantic analysis is performed on the first image to obtain the semantic analysis data, so that the semantic analysis data guides the image denoising, to ensure that an image object in the second image after denoising is the same as an image object in the first image. Further, feature similarities are compared to determine a defect condition of the image object in the first image, thereby improving accuracy and recognition efficiency of image object defect recognition.

The image processing apparatus provided by the foregoing embodiments is illustrated by using an example of division into the foregoing functional modules. In a practical application, the foregoing functions may be allocated to and completed by different functional modules according to a requirement, that is, an internal structure of the device is divided into different functional modules, to complete all or some of the foregoing described functions. In addition, the image processing apparatus and the image processing method provided in the foregoing embodiments belong to the same concept. For a specific implementation process, refer to the method embodiment, and the details are not described herein again.

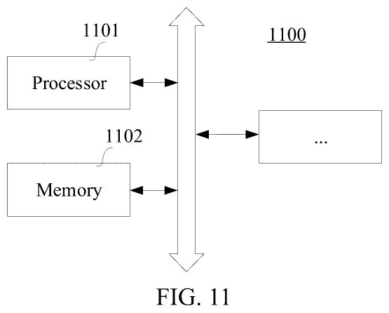

FIG. 11 is a structural block diagram of a computer device 1100 according to an embodiment of this disclosure. The computer device 1100 may be a portable mobile terminal, such as a smartphone, a tablet computer, a moving picture experts group audio layer III (MP3) player, a moving picture experts group audio layer IV (MP4) player, a notebook computer, or a desktop computer. The computer device 1100 may alternatively be referred to as a user equipment, a portable terminal, a laptop terminal, a desktop terminal, or the like.

In an example, the computer device 1100 includes processing circuitry (e.g., a processor 1101) and a memory 1102.

The processing circuitry (e.g., the processor 1101) may include one or more processing cores. For example, the processor 1101 may be a four-core processor or an eight-core processor. The processor 1101 may be implemented by using at least one hardware form of a digital signal processor (DSP), a field-programmable gate array (FPGA), or a programmable logic array (PLC). The processor 1101 may further include a main processor and a co-processor. The main processor is a processor configured to process data in a wakeup state, and is also referred to as a central processing unit (CPU); and the co-processor is a low-power processor configured to process data in a standby state. In some embodiments, the processor 1101 may be integrated with a graphics processing unit (GPU), and the GPU is configured to be responsible for rendering and drawing content that needs to be displayed on a display screen. In some embodiments, the processor 1101 may further include an artificial intelligence (AI) processor. The AI processor is configured to process a calculation operation related to machine learning.

The memory 1102 may include one or more computer-readable storage media, and the computer readable storage media may be non-transitory. In addition, the memory 1102 may further include a high-speed random access memory, and may further include a non-volatile memory such as one or more magnetic disk storage devices and flash storage devices. In some embodiments, the non-transitory computer-readable storage medium in the memory 1102 is configured to store at least one instruction. The at least one instruction is executed by the processor 1101 to implement the methods provided in this disclosure.

In some embodiments, the computer device 1100 may further include other components. A person skilled in the art may understand that a structure shown in FIG. 11 does not constitute a limitation to the computer device 1100, and the computer device 1100 may include more components or fewer components than the components shown in the figure, or some components may be combined, or a different component deployment may be applied.

In addition, an embodiment of this disclosure provides a storage medium (e.g., a non-transitory computer-readable storage medium), the storage medium being configured to have a computer program stored therein, and the computer program being configured to execute the method according to the foregoing embodiments.

An embodiment of this disclosure further provides a computer program product including the computer program, the computer program product, when running on a computer, making the computer perform the method according to the foregoing embodiments.

A person of ordinary skill in the art may understand that all or some of the operations of the methods in the foregoing embodiments may be implemented by the program instructing relevant hardware. The program may be stored in a computer-readable storage medium (e.g., a non-transitory computer-readable storage medium). The computer-readable storage medium may be a computer-readable storage medium included in the memory provided in the foregoing embodiments; or the computer-readable storage medium may exist independently, as a computer-readable storage medium not assembled into a terminal. The computer-readable storage medium stores at least one instruction, at least one program, and a code set or an instruction set, and the at least one instruction, the at least one program, and the code set or the instruction set are loaded and executed by the processor to implement the methods according to any one of the foregoing embodiments.

In some embodiments, the computer-readable storage medium may include: a read-only memory (ROM), a random access memory (RAM), a solid state drive (SSD), or an optical disc, and the like. The random access memory may include a resistance random access memory (ReRAM) and a dynamic random access memory (DRAM). The sequence numbers of the foregoing embodiments of this disclosure are merely for a description purpose and do not indicate superiority or inferiority of the embodiments.

The person of ordinary skill in the art may understand that all or some of the operations in the foregoing embodiments may be implemented by using hardware, or may be implemented by the program instructing the relevant hardware. The program may be stored in the computer-readable storage medium. The foregoing described storage medium may be a read-only memory, a magnetic disk, the optical disc, or the like.

The foregoing descriptions are merely some embodiments of this disclosure and are not intended to limit this disclosure. Any modification, equivalent replacement, or improvement are within the scope of this disclosure.

What is claimed is:

1. An image processing method, comprising:
obtaining a noise-added image corresponding to a first image by adding first noise data to the first image, and the first image comprising an image object;
performing a semantic analysis on the first image to obtain semantic analysis data representing the image object in the first image;
performing, based on the semantic analysis data, an image denoising process on the noise-added image, to obtain a second image; and
determining, by processing circuitry and based on a feature similarity between the first image and the second image, a defect recognition result corresponding to the first image, the defect recognition result indicating a defect condition of the image object in the first image.

2. The method according to claim 1, wherein the performing the semantic analysis comprises:
obtaining a downsampled first image of the first image;
performing an iterative feature encoding process on the downsampled first image, to obtain a plurality of pieces of semantic feature encoded data, an (i+1)th piece of semantic feature encoded data being obtained by performing a feature encoding process on an i^{th} piece of semantic feature encoded data, the plurality of pieces of semantic feature encoded data respectively corresponding to different feature dimensions, and i being a positive integer; and
performing a feature decoding process on at least one piece of semantic feature encoded data of the plurality of pieces of semantic feature encoded data, to obtain at least one piece of semantic feature decoded data as the semantic analysis data.

3. The method according to claim 2, wherein the performing the feature decoding process comprises:
performing a feature fusion process on at least two pieces of semantic feature encoded data of the plurality of pieces of semantic feature encoded data, to obtain a first fused feature representation; and
performing the feature decoding process on the first fused feature representation, to obtain the semantic feature decoded data as the semantic analysis data.

4. The method according to claim 3, wherein the at least two pieces of semantic feature encoded data includes an n^{th} piece of semantic feature encoded data and an m^{th} piece of semantic feature encoded data, the n^{th} piece of semantic feature encoded data including k layers of first semantic subdata, the m^{th} piece of semantic feature encoded data including k layers of second semantic subdata, and n, m, and k being positive integers; and
the performing the feature fusion process comprises:
performing a convolution process on the k layers of second semantic subdata, to obtain k convolution processing results;
performing the feature fusion process on the k convolution processing results and a j^{th} layer of first semantic subdata, to obtain a j^{th} layer of first fused sub-feature, 0<j≤k, j being an integer; and
obtaining, based on the k layers of first fused sub-feature, the first fused feature representation.

5. The method according to claim 2, wherein the performing the image denoising process comprises:
performing the iterative feature encoding process on the noise-added image, to obtain a plurality of pieces of denoised feature encoded data; and
performing, based on the semantic feature decoded data and the semantic feature encoded data, the iterative feature decoding process on a p^{th} piece of denoised feature encoded data of the plurality of pieces of denoised feature encoded data, to obtain the second image, p being a positive integer.

6. The method according to claim 5, wherein the performing the iterative feature encoding process comprises:
performing a feature fusion process on a q^{th} piece of denoised feature encoded data and the downsampled first image, to obtain a second fused feature representation, q<p, q being a positive integer; and
performing the iterative feature encoding process on the second fused feature representation, to obtain the plurality of pieces of semantic feature encoded data.

7. The method according to claim 5, wherein the performing the iterative feature decoding process comprises:
performing, based on the semantic feature decoded data and the semantic feature encoded data, the iterative feature decoding process on the p^{th} piece of denoised feature encoded data, to obtain second noise data indicating a prediction result of the first noise data;
performing, based on the second noise data, a data denoising process on the noise-added image, to obtain a data denoised feature representing an image feature representation corresponding to an image obtained from the noise-added image after the second noise data is removed; and
performing an image decoding process on the data denoised feature, to obtain the second image.

8. The method according to claim 7, further comprising:
performing a semantic segmentation process on target semantic feature encoded data of the plurality of pieces of semantic feature encoded data, to obtain a first semantic segmented feature representing a pixel classification result of the first image, wherein
the performing, based on the semantic feature decoded data and the semantic feature encoded data, the iterative feature decoding processing on the p^{th} piece of denoised feature encoded data comprises:
performing the semantic segmentation process on the p^{th} piece of denoised feature encoded data, to obtain a second semantic segmented feature representing a pixel classification result of the noise-added image;
performing a feature concatenation process on the first semantic segmented feature and the second semantic segmented feature, to obtain a semantic concatenated feature; and
performing, based on the semantic feature decoded data and the p^{th} piece of denoised feature encoded data, the iterative feature decoding process on the semantic concatenated feature, to obtain the second noise data.

9. The method according to claim 1, wherein the determining comprises:
extracting a first image feature representation corresponding to the first image and a second image feature representation corresponding to the second image;
obtaining, based on a cosine similarity between the first image feature representation and the second image feature representation, a defect score distribution image, a pixel value in the defect score distribution image indicating a difference between a pixel value in the first image and a pixel value in the second image;
performing a feature upsampling process on the defect score distribution image, to obtain a defect position distribution image indicating a position distribution condition in which the image object has a defect;
performing an average pooling process on the defect position distribution image, to obtain a defect category of the defect of the image object; and
wherein the defect recognition result includes the defect position distribution image and the defect category.

10. The method according to claim 1, wherein
the performing the semantic analysis includes obtaining, based on the first image, the semantic analysis data through a semantic analysis model; and
the performing the image denoising process includes
obtaining, based on the semantic analysis data and the noise-added image, the second image through an image denoising model.

11. The method according to claim 10, further comprising:
obtaining a sample noise-added image corresponding to a first sample image by adding first sample noise data to the first sample image;
obtaining, based on the first sample image, sample semantic analysis data through a sample analysis model;
obtaining, based on the sample semantic analysis data and the sample noise-added image, first predicted noise data through a sample denoising model; and
training, based on a difference between the first sample noise data and the first predicted noise data, the sample analysis model and the sample denoising model, to obtain the semantic analysis model and the image denoising model.

11. An image processing apparatus, comprising:
processing circuitry configured to:
obtain a noise-added image corresponding to a first image by adding first noise data to the first image, and the first image comprising an image object;
perform a semantic analysis on the first image to obtain semantic analysis data representing the image object in the first image;
perform, based on the semantic analysis data, an image denoising process on the noise-added image, to obtain a second image; and
determine, by processing circuitry and based on a feature similarity between the first image and the second image, a defect recognition result corresponding to the first image, the defect recognition result indicating a defect condition of the image object in the first image.

12. The apparatus according to claim 11, wherein the processing circuitry is configured to:
obtain a downsampled first image of the first image;
perform an iterative feature encoding process on the downsampled first image, to obtain a plurality of pieces of semantic feature encoded data, an (i+1)^{th} piece of semantic feature encoded data being obtained by performing a feature encoding process on an i^{th} piece of semantic feature encoded data, the plurality of pieces of semantic feature encoded data respectively corresponding to different feature dimensions, and i being a positive integer; and
perform a feature decoding process on at least one piece of semantic feature encoded data of the plurality of pieces of semantic feature encoded data, to obtain at least one piece of semantic feature decoded data as the semantic analysis data.

13. The apparatus according to claim 12, wherein the processing circuitry is configured to:
perform a feature fusion process on at least two pieces of semantic feature encoded data of the plurality of pieces of semantic feature encoded data, to obtain a first fused feature representation; and
perform the feature decoding process on the first fused feature representation, to obtain the semantic feature decoded data as the semantic analysis data.

14. The apparatus according to claim 13, wherein the at least two pieces of semantic feature encoded data includes an n^{th} piece of semantic feature encoded data and an m^{th} piece of semantic feature encoded data, the n^{th} piece of semantic feature encoded data including k layers of first semantic subdata, the m^{th} piece of semantic feature encoded data including k layers of second semantic subdata, and n, m, and k being positive integers; and
the processing circuitry is configured to:
perform a convolution process on the k layers of second semantic subdata, to obtain k convolution processing results;
perform the feature fusion process on the k convolution processing results and a j^{th} layer of first semantic subdata, to obtain a j^{th} layer of first fused sub-feature, 0<j≤k, j being an integer; and
obtain, based on the k layers of first fused sub-feature, the first fused feature representation.

15. The apparatus according to claim 12, wherein the processing circuitry is configured to:
perform the iterative feature encoding process on the noise-added image, to obtain a plurality of pieces of denoised feature encoded data; and
perform, based on the semantic feature decoded data and the semantic feature encoded data, the iterative feature decoding process on a p^{th} piece of denoised feature encoded data of the plurality of pieces of denoised feature encoded data, to obtain the second image, p being a positive integer.

16. The apparatus according to claim 15, wherein the processing circuitry is configured to:
perform a feature fusion process on a q^{th} piece of denoised feature encoded data and the downsampled first image, to obtain a second fused feature representation, q<p, q being a positive integer; and
perform the iterative feature encoding process on the second fused feature representation, to obtain the plurality of pieces of semantic feature encoded data.

17. The apparatus according to claim 15, wherein the processing circuitry is configured to:
perform, based on the semantic feature decoded data and the semantic feature encoded data, the iterative feature decoding process on the p^{th} piece of denoised feature encoded data, to obtain second noise data indicating a prediction result of the first noise data;
perform, based on the second noise data, a data denoising process on the noise-added image, to obtain a data denoised feature representing an image feature representation corresponding to an image obtained from the noise-added image after the second noise data is removed; and
perform an image decoding process on the data denoised feature, to obtain the second image.

18. The apparatus according to claim 17, wherein the processing circuitry is configured to:
perform a semantic segmentation process on target semantic feature encoded data of the plurality of pieces of semantic feature encoded data, to obtain a first semantic segmented feature representing a pixel classification result of the first image,
perform the semantic segmentation process on the p^{th} piece of denoised feature encoded data, to obtain a second semantic segmented feature representing a pixel classification result of the noise-added image;
perform a feature concatenation process on the first semantic segmented feature and the second semantic segmented feature, to obtain a semantic concatenated feature; and
perform, based on the semantic feature decoded data and the p^{th} piece of denoised feature encoded data, the iterative feature decoding process on the semantic concatenated feature, to obtain the second noise data.

19. The apparatus according to claim 11, wherein the processing circuitry is configured to:
extract a first image feature representation corresponding to the first image and a second image feature representation corresponding to the second image;
obtain, based on a cosine similarity between the first image feature representation and the second image feature representation, a defect score distribution image, a pixel value in the defect score distribution image indicating a difference between a pixel value in the first image and a pixel value in the second image;
perform a feature upsampling process on the defect score distribution image, to obtain a defect position distribution image indicating a position distribution condition in which the image object has a defect;
perform an average pooling process on the defect position distribution image, to obtain a defect category of the defect of the image object; and
wherein the defect recognition result includes the defect position distribution image and the defect category.

20. A non-transitory computer-readable storage medium, storing instructions which when executed by at least one processor cause the at least one processor to perform an image processing method, comprising:
obtaining a noise-added image corresponding to a first image by adding first noise data to the first image, and the first image comprising an image object;
performing a semantic analysis on the first image to obtain semantic analysis data representing the image object in the first image;
performing, based on the semantic analysis data, an image denoising process on the noise-added image, to obtain a second image; and
determining, by processing circuitry and based on a feature similarity between the first image and the second image, a defect recognition result corresponding to the first image, the defect recognition result indicating a defect condition of the image object in the first image.
